(19) United States
(12) Patent Application Publication
(10) Pub. No.: US 2026/0320906 A1
(43) Pub. Date: Oct. 15, 2026

(54) ROBUST UNPOSED THREE-DIMENSIONAL GAUSSIAN SPLATTING FOR CASUAL LONG VIDEOS USING OCTREE ANCHOR FORMATIONS

(71) Applicant: NVIDIA Corporation, Santa Clara, CA (US)

(72) Inventors: Fu-En Yang, Taipei City (TW); Min-Hung Chen, Zhubei City (TW); Cheng Sun, Hsinchu (TW); Chin-Yang Lin, Hsinchu City (TW); Yen-Yu Lin, Hsinchu (TW); Yu-Lun Liu, Hsinchu City (TW)

(21) Appl. No.: 19/324,259

(22) Filed: Sep. 10, 2025

Related U.S. Application Data
(60) Provisional application No. 63/788,488, filed on Apr. 14, 2025.

(51) Int. Cl. G06T 15/20; G06T 7/70

(52) U.S. Cl. CPC G06T 15/205; G06T 7/70; G06T 2207/10016; G06T 2207/10024; G06T 2207/10028; G06T 2207/20081; G06T 2207/20084; G06T 2207/30244; G06T 2210/56

(57) ABSTRACT

Systems and methods are disclosed for novel view synthesis (NVS) using a three-dimensional (3D) Gaussian Spatting (3DGS) framework. For example, embodiments of the present disclosure may obtain an input video comprising a plurality of frames and train the 3DGS framework to obtain training outputs comprising estimated camera poses for each of the plurality of frames, octree anchor formations comprising anchor points indicating a center of each of a plurality of octree anchor formation voxels that are based on a voxel density of the corresponding octree anchor formation voxel, and a multi-layer perceptron (MLP) that determines 3DGS parameters based on the octree anchor formations. Subsequently, an inference input indicating an inference camera pose may be obtained and an inference output from a viewpoint indicated by the inference camera pose may be generated.

### CLAIM OF PRIORITY

This application claims the benefit of U.S. Provisional Application No. 63/788,488 (Attorney Docket No. 515454) titled “Longsplat: Robust Unposed 3d Gaussian Splatting For Casual Long Videos,” filed Apr. 14, 2025, the entire contents of which is incorporated herein by reference.

### BACKGROUND

High-quality three-dimensional (3D) reconstruction and novel view synthesis (NVS) are essential for applications such as virtual reality, augmented reality, virtual tourism, and/or cultural heritage preservation. They also play a crucial role in video editing tasks such as stabilization, visual effects, and digital mapping for real estate or pedestrian-level navigation. With the widespread availability of smartphones and action cameras, casually captured videos have emerged as a significant source of 3D content. Unlike professionally acquired datasets, casual videos present challenging characteristics such as, but not limited to, irregular camera trajectories, long sequences spanning hundreds or thousands of frames, and/or the absence of reliable camera poses or precise geometric priors.

Addressing NVS from casually captured videos poses two critical challenges: 1) accurate camera pose estimation over extended trajectories; and 2) efficient representation of large-scale scenes. One set of conventional approaches may rely on precise poses from Structure-from-Motion (SfM) preprocessing, but this set may frequently fail in casual settings. Other conventional approaches may also encounter severe memory constraints, which limit their effectiveness for large-scale scenarios. Yet even other conventional approaches such as conventional foundation models provide fast initial estimates, but they suffer from inaccuracies and drift in long videos, which severely affect reconstruction quality. Similarly, other conventional approaches struggle with complex camera trajectories, resulting in fragmented reconstructions. As such, there is a need for addressing these issues and/or other issues associated with the prior art.

### SUMMARY

Embodiments of the present disclosure relate to robust unposed three-dimensional (3D) Gaussian Splatting (3DGS) for casual long videos using octree anchor formations. For instance, to address the limitations from the conventional approaches, embodiments of the present disclosure provide a robust unposed 3DGS framework (LongSplat framework) that may be configured specifically for casual long videos. The LongSplat framework may achieve accurate NVS without relying on provided camera poses. The LongSplat framework may also depart from traditional pipelines by jointly optimizing camera poses and 3DGS in a unified framework. The LongSplat framework may integrate a correspondence-guided Pose Estimation module and/or process with 3DGS geometry and photometric refinements to improve pose accuracy, even under large-scale and unstructured camera motion. Furthermore, an adaptive Octree Anchor Formation process and/or algorithm may dynamically adjust anchor densities in the 3DGS representation, drastically reducing memory usage while preserving detailed scene structures. These components of the LongSplat framework may work together in an incremental joint optimization approach that avoids local minima and ensures global geometric consistency across extensive sequences.

For instance, the LongSplat framework addresses critical challenges in NVS from casually captured long videos characterized by irregular camera motion, unknown camera poses, and/or expansive scenes. In some instances, prior approaches often suffer from pose drift, inaccurate geometry initialization, and/or severe memory limitations. To address these issues, the LongSplat framework may be configured for incremental joint optimization that concurrently optimizes camera poses and 3D Gaussians to avoid local minima and ensure global consistency. Additionally, and/or alternatively, the LongSplat framework may include a pose estimation module that leverages learned 3D priors and an adaptive octree anchor formation mechanism that dynamically adjusts anchor densities, which significantly reduces memory usage. Extensive experiments on challenging benchmarks demonstrated that the LongSplat framework achieves state-of-the-art results, substantially improving rendering quality, pose accuracy, and computational efficiency compared to prior approaches.

In an embodiment, a computer-implemented method for NVS using a 3DGS framework is provided. The method includes obtaining an input video comprising a plurality of frames and training the 3DGS framework to obtain training outputs comprising estimated camera poses for each of the plurality of frames, octree anchor formations comprising anchor points indicating a center of each of a plurality of octree anchor formation voxels that are based on a voxel density of the corresponding octree anchor formation voxel, and a multi-layer perceptron (MLP) that determines 3DGS parameters based on the octree anchor formations. The method further includes obtaining an inference input indicating an inference camera pose and generating an inference output from a viewpoint indicated by the inference camera pose based on the estimated camera poses, the octree anchor formations, and the MLP.

### BRIEF DESCRIPTION OF THE DRAWINGS

The present systems and methods for robust unposed 3DGS for casual long videos using octree anchor formations are described in detail below with reference to the attached drawing figures, wherein:

FIG. 1A shows an overview for the LongSplat framework, in accordance with one or more embodiments of the present disclosure.

FIG. 1B shows a block diagram describing the training phase and the inference phase for the LongSplat framework, in accordance with one or more embodiments of the present disclosure.

FIG. 1C is another block diagram that describes the training phase for the LongSplat framework, in accordance with one or more embodiments of the present disclosure.

FIGS. 2A-2G show algorithms and/or processes for the LongSplat framework, in accordance with one or more embodiments of the present disclosure.

FIG. 3 illustrates a flowchart of a method for NVS using a 3DGS framework, in accordance with one or more embodiments of the present disclosure.

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

To address the limitations from the conventional approaches, embodiments of the present disclosure provide a robust unposed 3D Gaussian Splatting (3DGS) framework (LongSplat framework) that may be configured specifically for casual long videos. The LongSplat framework may achieve accurate NVS without relying on provided camera poses. The LongSplat framework may also depart from traditional pipelines by jointly optimizing camera poses and 3DGS in a unified framework. The LongSplat framework may integrate a correspondence-guided Pose Estimation module and/or process with 3DGS geometry and photometric refinements to improve pose accuracy, even under large-scale and unstructured camera motion. Furthermore, an adaptive Octree Anchor Formation process and/or algorithm may dynamically adjust anchor densities in the 3DGS representation, drastically reducing memory usage while preserving detailed scene structures. These components of the LongSplat framework may work together in an incremental joint optimization approach that avoids local minima and ensures global geometric consistency across extensive sequences.

For instance, the LongSplat framework addresses critical challenges in NVS from casually captured long videos characterized by irregular camera motion, unknown camera poses, and/or expansive scenes. Specifically, conventional approaches may often suffer from pose drift, inaccurate geometry initialization, and/or severe memory limitations. To address these issues, embodiments of the present disclosure describe a LongSplat framework, which may be a robust unposed 3DGS framework featuring: (1) incremental joint optimization that concurrently optimizes camera poses and 3D Gaussians to avoid local minima and ensure global consistency; (2) a pose estimation module leveraging learned 3D priors; and (3) an adaptive octree anchor formation mechanism that dynamically adjusts anchor densities, significantly reducing memory usage.

Extensive experiments on challenging benchmarks demonstrate that LongSplat framework achieves state-of-the-art results, substantially improving rendering quality, pose accuracy, and computational efficiency compared to prior approaches. For instance, these extensive experiments were conducted on challenging datasets, and demonstrated that the LongSplat framework consistently outperforms conventional approaches, significantly improving rendering quality and pose accuracy. Compared to conventional approaches, the LongSplat framework produces clearer and more coherent reconstructions, effectively addressing pose drift and memory limitations and substantially advancing the state-of-the-art. The LongSplat framework is described in further detail below.

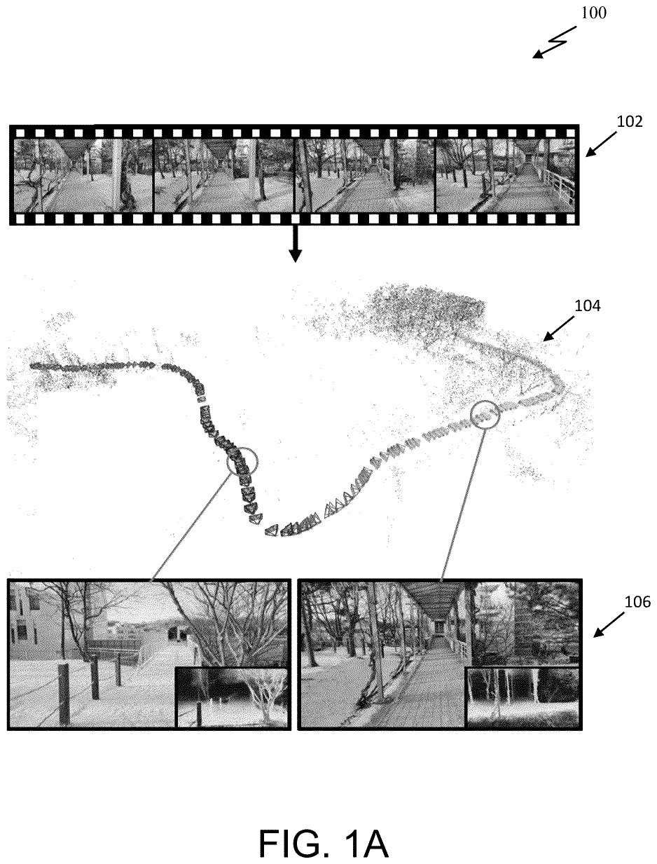

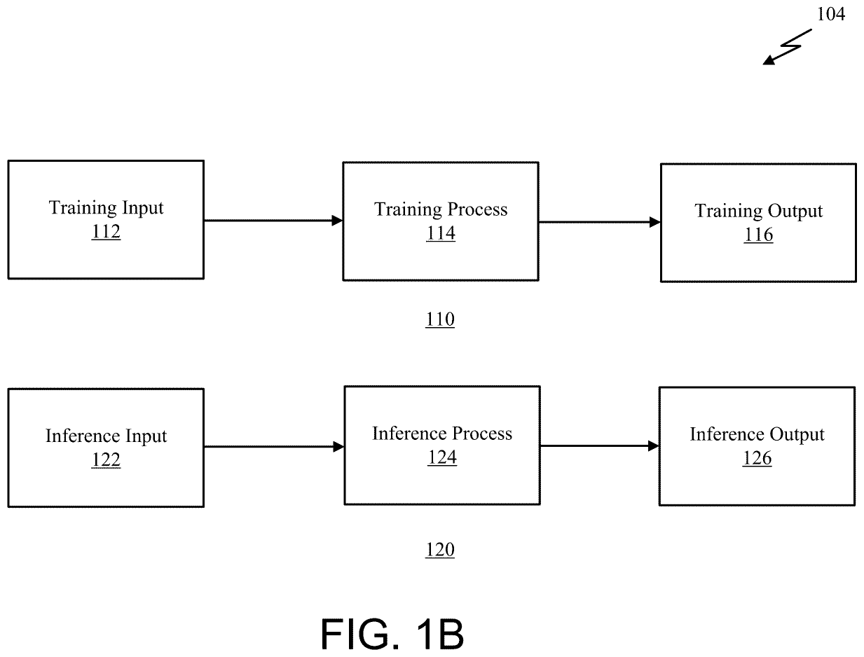

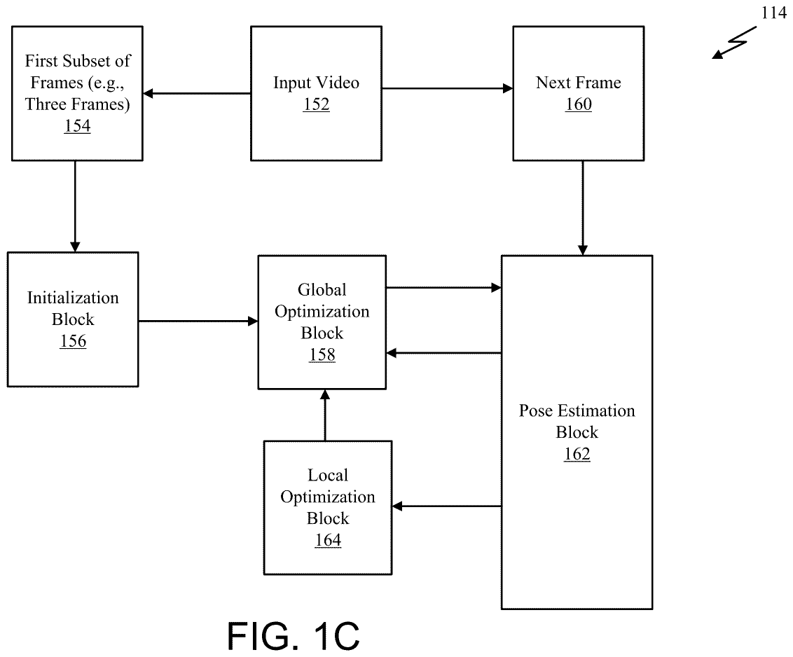

FIG. 1A shows an overview 100 for the LongSplat framework 104, in accordance with one or more embodiments of the present disclosure. For instance, the LongSplat framework 104 may achieve robust NVS from casually captured long videos without provided camera poses. For instance, the input video 102 may be a casually captured long video without camera poses. The input video 102 may be any type of video and/or be any duration in length (e.g., a five-minute video or an hour-long video). The input video 102 may be captured using a computing device such as a mobile phone and/or smartphone and the camera poses associated with the computing device might not be used and might not be provided to the LongSplat framework 104. For instance, the input video 102 may be captured by a user as they are running through an environment. Thus, the input video 102 might not be steady given that the user is running and holding the computing device and may show different objects in different frames of the input video 102 as the user is running through the environment. The output 106 may include a high-quality NVS (e.g., a high-quality image and/or video) from jointly optimized camera poses and/or 3DGS. FIG. 1B shows and describes the LongSplat framework 104 in more detail.

FIG. 1B shows a block diagram describing the training phase 110 and the inference phase 120 for the LongSplat framework 104, in accordance with one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the LongSplat framework 104 is within the scope and spirit of embodiments of the present disclosure.

Prior to describing the LongSplat framework 104 in more detail, a summary and preliminaries are first described. For instance, the LongSplat framework 104 reconstructs long video sequences with unknown camera poses and unconstrained trajectories through a fully incremental pipeline based on octree-anchored 3DGS. The process may begin with octree anchor formation, where per-frame dense point clouds are structured into an adaptive representation. Next, camera poses may be estimated and refined using correspondence-guided initialization and photometric alignment. Further, the reconstruction alternates between local optimization, which updates Gaussians within a visibility-adapted window, and global refinement, which ensures long-term consistency. This process may allow the LongSplat framework 104 to robustly handle long, unconstrained trajectories while adapting to scene complexity and minimizing drift.

Preliminaries are now described. For instance, 3DGS may represent the scene as a set of 3D Gaussians, each defined by a center μ ∈ [symbol] ³, a covariance matrix Σ, color, scale, rotation, and opacity. The covariance is factorized into a rotation R∈SO(3) and a diagonal scale matrix S, giving:

$$G ( x ) = {e}^{- \frac{1}{2} {( x - μ )}^{T} {\sum }^{- 1} ( x - μ )} , \qquad ( 1 )$$

$$\sum = {RSS}^{T} {R}^{T}$$

This parameterization allows each Gaussian to adaptively capture local scene geometry.

To render the scene, each Gaussian is projected onto the image plane using the camera pose W, resulting in a 2D Gaussian with covariance Σ_{2D}=JWΣW^{T}J^{T}, where J is the Jacobian of the projective transformation. The final rendered color and depth is computed via alpha blending:

$$C = {\sum }_{i = 1}^{N} {c}_{i} {α}_{i} {\prod }_{j = 1}^{i - 1} ( 1 - {α}_{j} ) , \qquad ( 2 )$$

$$D = {\sum }_{i = 1}^{N} {d}_{i} {α}_{i} {\prod }_{j = 1}^{i - 1} ( 1 - {α}_{j} )$$

where cᵢ and αᵢ denote the color and opacity of the i-th Gaussian, respectively. dᵢ denotes the depth value along the ray at the Gaussian's center.

Anchor-based 3DGS is now described. To enhance memory efficiency and robustness in large scenes, a previous approach introduced the anchor-based 3DGS representation. Instead of directly maintaining individual Gaussians, the scene is first divided into sparse voxels, each acting as an anchor. From each anchor, k Gaussians are initialized with positions relative to the anchor center:

{μ₀,μ₁, . . . ,μₖ₋₁}=xᵥ+{O₀,O₁, . . . ,Oₖ₋₁}·lᵥ (3)

where xᵥ denotes the anchor position, {Oᵢ} are offset vectors, and lᵥ is a scaling factor. Each Gaussian's opacity, rotation, scale, and color are decoded from an anchor feature through lightweight MLPs. For opacity, the formulation is:

{α₀,α₁, . . . ,αₖ₋₁}=Fₐ(\hat{f}ᵥ,Δv_{c},\hat{d}ᵥ) (4)

where F_{α} is a multilayer perceptron (MLP) taking the anchor feature \hat{f}ᵥ, the relative view distance Δv_{c}, and the view direction \hat{d}ᵥ as inputs.

Anchor initialization is now described. For instance, in traditional approaches, initial anchors are derived from sparse SfM point clouds. Points are voxelized to form anchor centers:

$$V = \{ v \vert v = ⌊ \frac{p}{ϵ} ⌋ \cdot ε , ∀ p ∈ P \} \qquad ( 5 )$$

where P is the SfM point cloud and ϵ is the voxel size. Each anchor holds a local feature, managing its associated Gaussians. This design ensures structured densification and pruning, adapting Gaussian density to scene complexity and improving both memory and rendering efficiency.

Turning back to FIG. 1B and the LongSplat framework 104, during the training phase 110, the training input 112 (e.g., the input video 102 from FIG. 1A) is provided to the training process 114 to obtain the training output 116. For example, the training input 112 may include the casually-captured long video (e.g., a sequence of frames from the input video 102). For instance, the video may be captured by a computing device such as a mobile phone (e.g., smartphone). Thus, the camera poses associated with the computing device that captured the video might not be known, and therefore, it may be difficult to perform NVS for the video. Prior to performing NVS, the training process 114 is used to obtain training output 116. The training output 116 may include Octree anchor formations for objects within the input video 102 (e.g., the anchor set), estimated camera poses for each frame from the input video 102 (e.g., the optimized camera calibration), and/or one or more trained MLPs (e.g., three shared lightweight 2-layer MLPs).

For example, in some embodiments, after performing the training process 114, the training output 116 may include and/or store three artifacts—the anchor set, three shared lightweight 2-layer MLPs, and the optimized camera calibration—for use during the inference phase 120. For instance, the anchor set (e.g., the Octree anchor formations) may include a plurality of anchors. Each anchor may store its center (e.g., the x, y, and z coordinates), a learned feature vector, a global scale value, and a fixed list of “k” relative offsets that define where its “k” Gaussians sit. In some examples, no per-Gaussian parameters (e.g., opacity, color, and so on) may be materialized and/or instead. Instead, when used, the per-Gaussian parameters may be generated on-the-fly. Further, the training output 116 may include three shared lightweight 2-layer MLPs. Given an anchor feature plus view-dependent inputs, the MLPs may decode the Gaussian parameters such as color, opacity, rotation, and scale for those “k” Gaussians. Because the MLPs may be shared, the MLPs may be saved once and reused for every anchor. In addition, the training output 116 may include the optimized camera calibration (e.g., the estimated camera poses). For instance, the optimized camera calibration may include one 4×4 extrinsic matrix per training frame and single intrinsic tuple (fₓ, f_{y}, cₓ, c_{y}). These matrices may be used by the inference renderer for reprojection. In some instances, the training output 116 may include only the anchor set, the three MLPs, and the calibrated camera parameters (e.g., no other data and/or information such as weights may be required for the inference phase 120).

After completing the training phase 110, the inference phase 120 is performed. For instance, as mentioned above, the inference phase 120 may utilize three pre-computed assets from the training phase 110 (e.g., the anchors, the shared 2-layer MLPs, and the calibrated camera intrinsics). For example, during the inference phase 120, inference input 122 such as a user supplied camera pose may be obtained. Given the user supplied camera pose, embodiments of the present disclosure may select all anchors inside the view frustum, and its latent feature vector and the view direction are fed into the MLP decoders to predict per-Gaussian RGB color, opacity α, anisotropic scale S, and rotation R. These predictions may be attached to the anchor's “k” Gaussians, whose centers are obtained by adding the fixed relative offsets to the anchor center and scaling by the anchor's global scale. The full set of Gaussians may then be rasterized by an Elliptical Weighted Average (EWA) 3D Gaussian splatting renderer, yielding a novel-view red green blue (RGB) image. Repeating this step for a list of poses produces an inference output 126 such as a video. In some examples, no additional optimization or fine-tuning may be performed during the inference phase 120.

In other words, based on the inference input 122 and performing the inference process 124, an inference output 126 is generated. The inference output 126 may be and/or include the output 106 from FIG. 1A (e.g., an NVS image and/or video comprising a sequence of inference frames). For instance, the inference input 122 may include user input indicating one or more inference camera poses. Based on the inference camera pose(s), the inference process 124 may use the training outputs 116 to generate a novel image and/or video. For instance, a user may seek to generate an image from a particular camera pose that is different from the camera viewpoints poses from the original input video 102. Thus, the user may provide inference input 122 indicating a new camera pose and using the inference process 124, an image and/or video from the perspective of the camera pose indicated by the inference input 122 may be generated. For example, as will be described in further detail below, the inference process 124 may use a trained MLP to obtain 3DGS parameters (e.g., color parameters, scale parameters, rotation parameters, and/or opacity parameters) from the Octree anchor formations. Subsequently, based on the obtained 3DGS parameters and the inference input 122 (e.g., the new camera pose), a renderer (e.g., an EWA volume spatting renderer) may be used to generate the inference output 126 (e.g., the NVS image and/or frame).

FIG. 1C is another block diagram that describes the training phase 114 for the LongSplat framework 104, in accordance with one or more embodiments of the present disclosure. For example, FIG. 1C describes the training phase 114 in more detail. The training process 114 includes the input video 152, a first subset of frames 154, an initialization block 156, a global optimization block 158, a next frame 160, a pose estimation block 162, and a local optimization block 164.

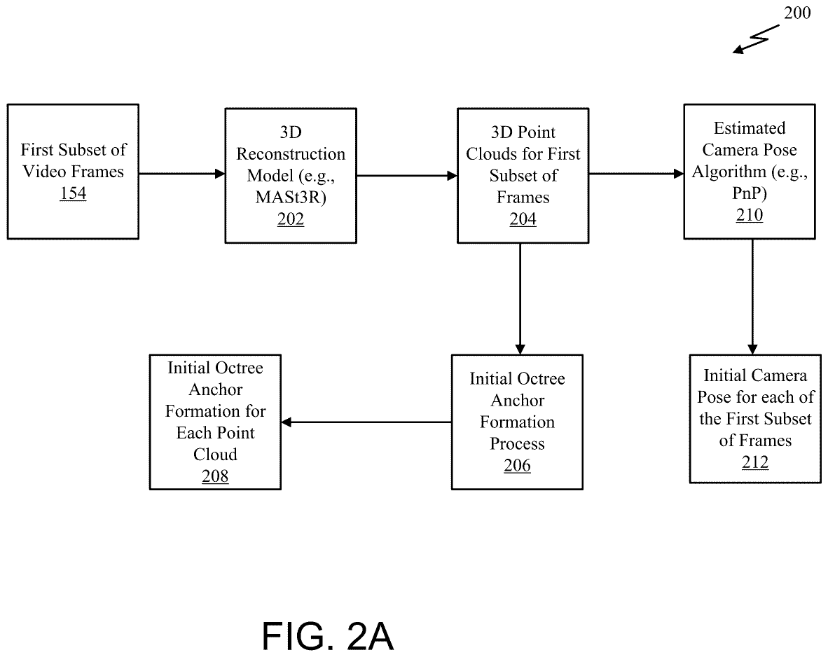

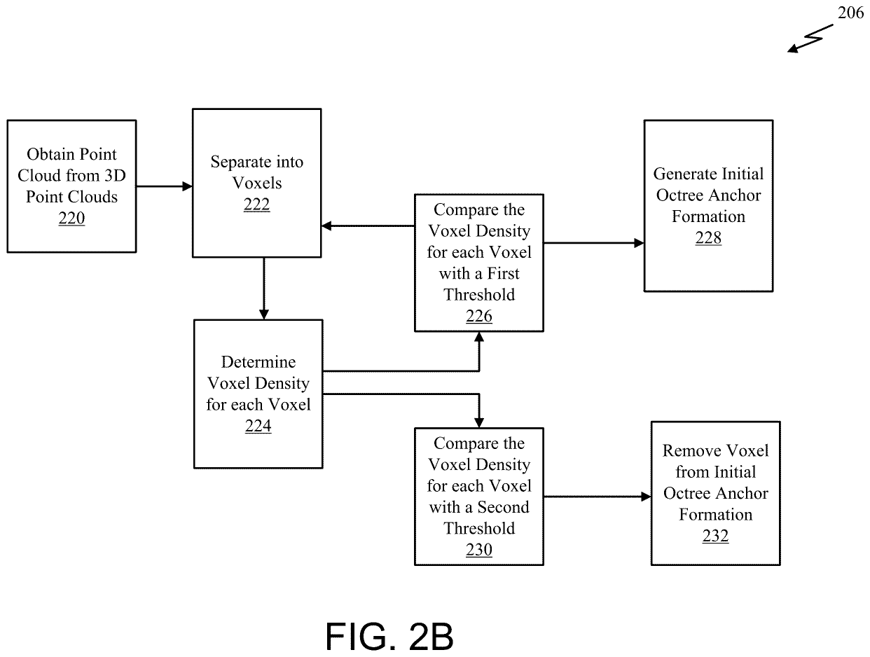

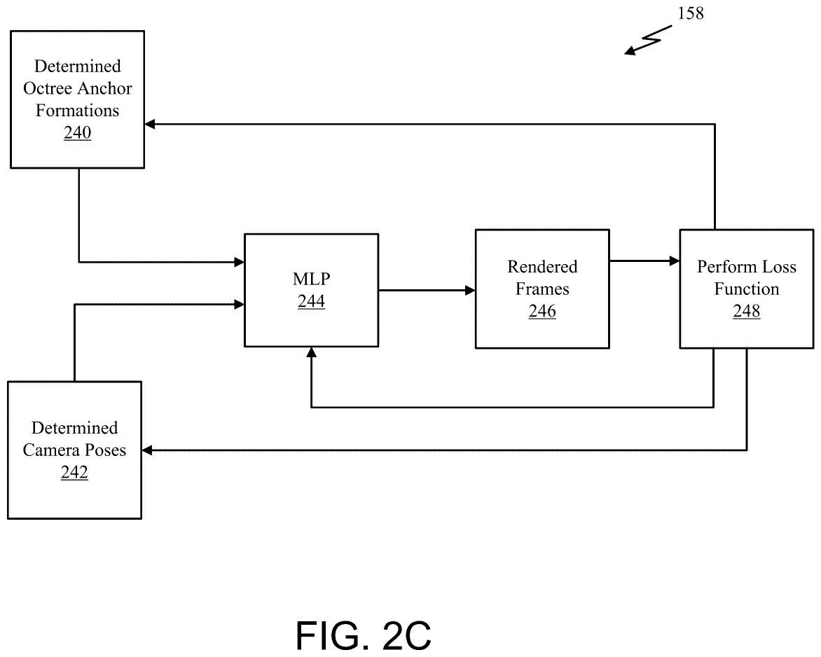

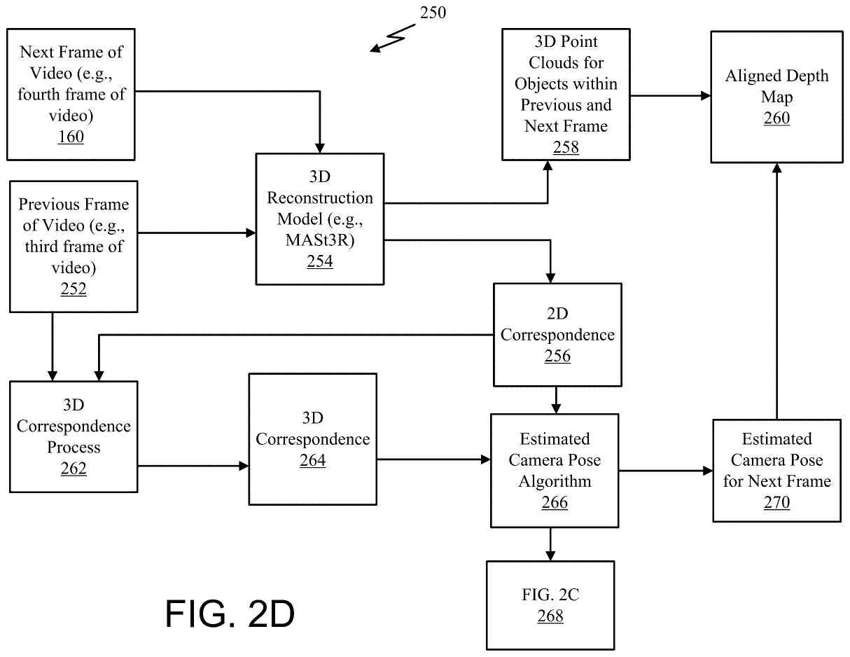

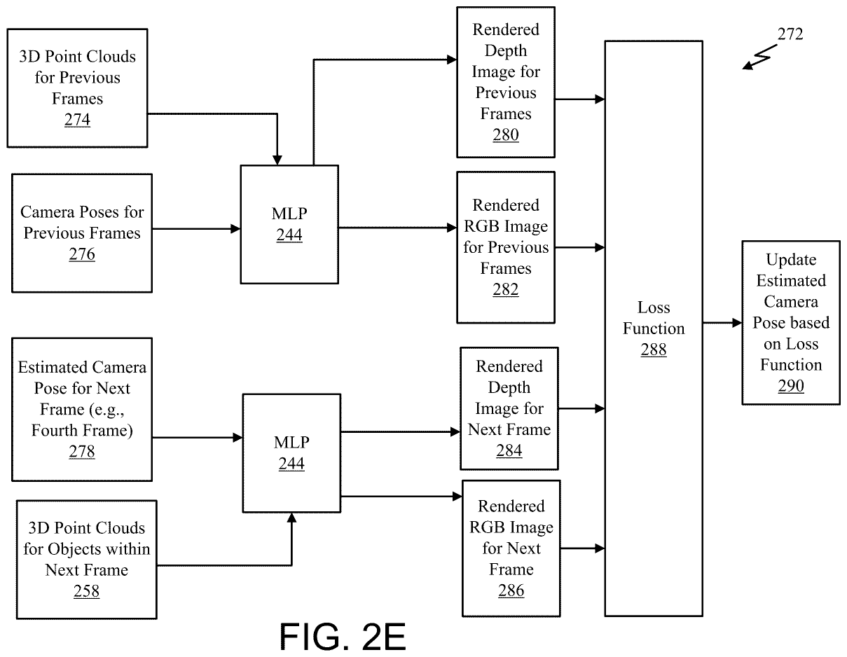

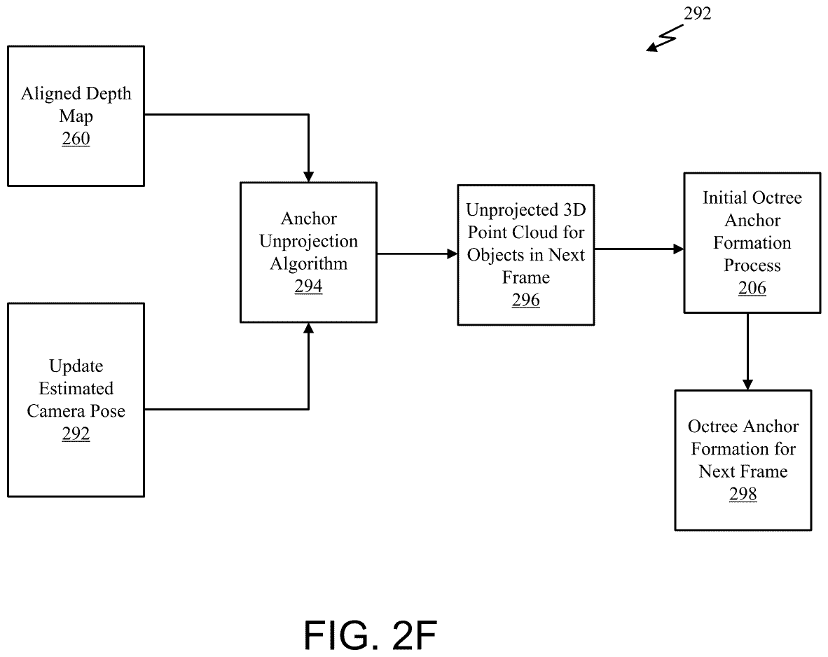

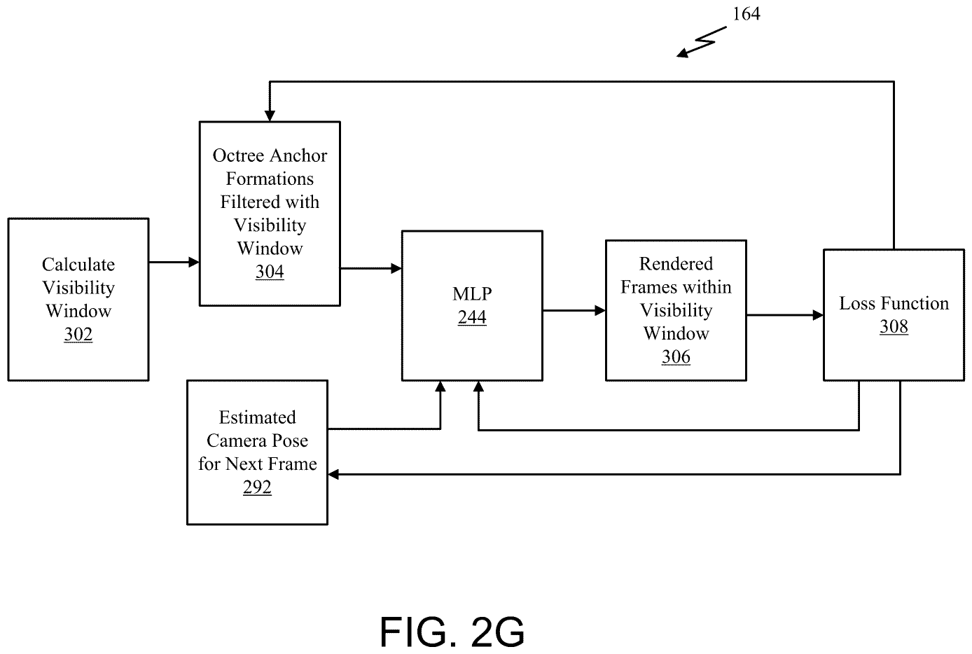

For instance, the input video 152 may be the input video 102 from FIG. 1A and may include a plurality of frames (e.g., one hundred frames). The input video 102 may be separated into a first subset of frames 154 and a second subset of frames. The first subset of frames 154 (e.g., the first three frames) may be provided to the initialization block 156, and subsequently, the next frame 160 from the second subset of frames may be provided to the pose estimation block 162. The initialization block 156 may perform initialization of the training process, which may include generating an initial octree anchor formation for objects within the first subset of frames 154, determine initial camera poses for the first subset of frames 154 (e.g., three estimated camera poses for the first three frames), and initialize an MLP (e.g., the MLP described above that is used during the inference process 124). For instance, the MLP may include a plurality of parameters, and during initialization, the parameters of the MLP may be randomly initialized. Subsequently, as will be described below, the parameters of the MLP may be trained during the training process 114 prior to using the MLP during the inference process 124, which is described above. The generation of the initial octree anchor formation and the determination of the initial camera poses will be described in FIG. 2A.

FIGS. 2A-2G show algorithms and/or processes for the LongSplat framework, in accordance with one or more embodiments of the present disclosure Each block of the algorithms and/or processes from FIGS. 2A-2G, described herein, comprises a computing process that may be performed using any combination of hardware, firmware, and/or software. For instance, various functions may be carried out by a processor executing instructions stored in memory. The algorithms and/or processes from FIGS. 2A-2G may also be embodied as computer-usable instructions stored on computer storage media. The algorithms and/or processes from FIGS. 2A-2G may be provided by a standalone application, a service or hosted service (standalone or in combination with another hosted service), or a plug-in to another product, to name a few. The algorithms and/or processes from FIGS. 2A-2G may be executed by any one system, or any combination of systems, including, but not limited to, those described herein. Furthermore, persons of ordinary skill in the art will understand that any system that performs the algorithms and/or processes from FIGS. 2A-2G is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

FIG. 2A shows a process 200 for initializing the LongSplat framework 104 using the initialization block 156. For example, as will be described below, process 200 begins with a small set of initial frames (e.g., the first subset of video frames 154). Camera poses (e.g., the initial camera pose 212) and dense point clouds (e.g., the 3D point clouds 204) for these frames 154 are estimated using a 3D reconstruction model 202, followed by converting the point cloud into an initial octree-anchored 3DGS (e.g., the initial Octree Anchor Formation 208) using an initial octree anchor formation process 206. In some instances, when camera intrinsics are unavailable, embodiments of the present disclosure may directly adopt the predicted focal length from the 3D reconstruction model 202.

For instance, the first subset of video frames 154 may be provided to a 3D reconstruction model to generate 3D point clouds 204 for the first subset of video frames 154. The 3D reconstruction model may be any type of 3D reconstruction model that is configured to generate 3D point clouds. In some variations, the 3D reconstruction model may be a Matching and Stereo 3D Reconstruction (MASt3R) model that is configured to process video frames to generate 3D point clouds associated with the video frames. In some instances, the 3D point clouds may be associated with objects within the first subset of video frames 154. For example, the first frame and the second frame from the first subset of video frames 154 may include two objects. The third frame from the first subset of video frames 154 may include three objects. The 3D reconstruction model may process the three frames from the first subset of video frames 154 to generate 3D point clouds 204 (e.g., three point clouds) for the three objects within the first subset of video frames 154.

Then, using the generated 3D point clouds 204, the initial Octree Anchor Formation 208 as well as the initial camera pose 212 for each of the first subset of frames 154 may be determined. For instance, an estimated camera pose algorithm 210 may be used to process the 3D point clouds to determine the initial camera poses 212 for each of the first subset of frames. For example, in some instances, the estimated camera pose algorithm 210 may be and/or include a Perspective-n-Point (PnP) algorithm that is configured to determine the camera pose (e.g., position and orientation of a camera) based on a set of known 3D points (e.g., from a 3D point cloud). Based on using the estimated camera pose algorithm 210, the initial camera poses 212 may be determined for the first subset of video frames 154 (e.g., a first estimated camera pose for the first frame, a second estimated camera pose for the second frame, and a third estimated camera pose for the third frame).

The initial Octree Anchor Formation process 206 is described in FIG. 2B, which determines the initial Octree anchor formations associated with the 3D point clouds 204. For instance, given an initial sparse voxelized point cloud, embodiments of the present disclosure iteratively perform density-guided adaptive voxel splitting and pruning. For example, voxels with point cloud density (p) exceeding a threshold are split, while those with density below the threshold are pruned. Repeated across multiple octree levels, this adaptive octree anchor design significantly reduces memory usage, allowing efficient representation and rendering of large-scale scenes.

In other words, for each point cloud from the 3D point clouds, the training process 114 may perform the initial Octree Anchor Formation process 206. As such, in the example above with three objects within the first subset of frames 154, the training process 114 may perform the initial Octree Anchor Formation process 206 three times. In operation, at block 220, a point cloud from the 3D point clouds is obtained. The obtained point cloud may be associated with the global coordinates of the frame. At block 222, a 3D scene is separated into voxels (e.g., eight voxels). For example, to perform NVS, the LongSplat framework 104 may seek to represent the input video 102 as one or more 3D scenes with 3DGS parameters. As such, at block 222, initially, the entire 3D scene may be separated into voxels. For instance, the 3D scene may initially be a cube and each voxel (e.g., each of the eight voxels) may represent a corner of the cube. At block 224, a voxel density may be determined for each voxel. For example, the voxel density may indicate a density of points of the point cloud that are within the voxel. For instance, if the point cloud includes 100 points and 10 points are within the voxel (e.g., within the corner of the 3D scene/cube), the voxel density may be 0.1. At blocks 226 and 230, the voxel densities are then compared to two thresholds—a density threshold and a prune threshold.

For instance, at block 226, the voxel density for each voxel is compared with a first threshold (e.g., the density threshold). Based on the comparison, the process 206 moves to block 228 or back to block 222. For instance, the density threshold may be utilized to avoid having voxels with a substantial amount of points from the 3D point cloud (e.g., 90% of the points of the point cloud). For example, in a frame of the input video 102, an object such as a fire hydrant might not be located in the center of the frame and instead may be located to one portion of the frame (e.g., the left portion). As such, when splitting the 3D scene into voxels, certain voxels may include a number of points from the point cloud whereas other voxels might not include as many points. Thus, the density threshold may be used to avoid having voxels include too many points from the 3D point cloud. Therefore, based on a comparison of the voxel density for the voxel with the density threshold, the process 206 may move back to block 222. For instance, based on the voxel having a voxel density indicating a substantial amount of points from the point cloud, block 222 may be performed again to separate the voxel into additional voxels (e.g., eight additional voxels). Thus, in the example of the fire hydrant on the left portion, a voxel associated with the left portion of the 3D scene may be split into eight separate voxels. Then, at block 224, a voxel density may be determined for each of the new eight separate voxels and at block 226, each of these voxel densities may be compared with the density threshold.

At block 228, process 206 may generate the initial Octree anchor formations. For example, as mentioned above, instead of representing a 3D scene using 3D Gaussians, which may be memory intensive, anchor-based 3DGS may be used that divides the 3D scene into voxels and a data structure indicating an anchor point (e.g., center) of the voxel may be generated for each voxel. Process 206 may be used to determine the anchor points for the voxels such that instead of having each of the voxels being the same size, the voxels are determined based on the voxel density of the point cloud itself. Therefore, at block 228, the initial Octree anchor formations, which may indicate the data structures of the voxels including the anchor points, may be generated. For example, for each point cloud, an initial Octree Anchor Formation may be generated comprising a plurality of data structures, each associated with a voxel after the voxel has separated according to the density threshold. Thus, each of the data structures may indicate an anchor point (e.g., a center point) as well as the other features (e.g., offsets such as ten offsets and a global scale parameter). Initially, during the initialization block 156, other than the anchor point, the other data within the data structures may be randomly initialized. For instance, the offsets, the global scale parameter, and the anchor features may be randomly initialized, and then, the training process 114 may be used to optimize this data for the Octree anchor formations.

In addition to using the density threshold, at block 230, the voxel densities may also be compared with a second threshold (e.g., a prune threshold). Based on the voxel density being below the prune threshold (e.g., there are a few points of the 3D point cloud that are within the voxel), at block 232, the voxel is removed from the Initial Octree Anchor Formation. For instance, in the example above, the fire hydrant might be located within the left portion and therefore, the voxels associated with the right portion may include zero or very few points from the point cloud. Based on using block 230, these voxels may be removed from the Initial Octree Anchor Formation. In some examples, blocks 230 and 232 may be performed after performing blocks 226 and 228. In other examples, blocks 230 and 232 may be performed in parallel with performing blocks 226 and 228.

In other words, in large-scale casual video settings, memory efficiency and scene adaptability are essential. The Octree Anchor Formation from embodiment of the present disclosure may dynamically adjust spatial resolution based on observed geometry, enabling scalable and redundant-free anchor management. For instance, the LongSplat framework 104 may construct structured anchors from MASt3R's per-frame dense point clouds using an adaptive octree. Unlike previous approaches, which may rely on a fixed-resolution grid, embodiments of the present disclosure may progressively subdivide space based on local point density. Each point cloud P={pᵢ} may be voxelized into a sparse grid at resolution ϵ₀. Voxels exceeding a density threshold τₛₚₗᵢₜ may be split into eight smaller voxels:

$${ϵ}_{l + 1} = \frac{1}{2} {ϵ}_{l} \qquad ( 6 )$$

where l represents the level. This process repeats up to a maximum level L. Low-density voxels (density βᵥ<τₚᵣᵤₙₑ) may be removed to reduce redundancy.

Each anchor may inherit a spatial scale proportional to its voxel size, ensuring coarse anchors for sparsely observed areas and finer anchors for detailed regions. To further prevent unnecessary duplication, newly generated anchors may be compared to existing ones. If significant spatial overlap exists, the new anchor may be discarded. This density-adaptive, duplication-free octree formation may ensure compact memory usage while preserving adaptive resolution across scenes.

Returning back to FIG. 2A, based on performing process 206, the initial Octree anchor formations for each point cloud 208 may be determined. After performing the initialization block 156 and returning back to FIG. 1C, the global optimization block 158 may be performed, which is described by FIG. 2C. For instance, referring to FIG. 2C based on the determined Octree anchor formations 240 and the determined camera poses 242, the MLP 244 may be used to generate rendered frames 246. For example, initially, aspects of the determined Octree anchor formations 240 and/or the determined camera poses 242 may be obtained from the initialization block 156 (e.g., the determined Octree anchor formations 240 may be initial Octree anchor formations 208 and the determined camera poses 242 may be the initial camera poses 212 for the first subset of frames 154). The MLP 244 may process the obtained information to determine the Gaussians for the scene (e.g., the 3DGS parameters described above), and the rendered frames 246 may be determined based on the determined Gaussians. For instance, from the determined Octree anchor formations 240 and/or the determined camera poses 242, the anchor's latent features and/or the view-dependent direction/distance term may be input into the MLP 244. Based on the inputs, the MLP 244 may decode the Gaussian attributes, and a Gaussian rasterizer (e.g., an EWA renderer) may perform the actual image rendering. Initially, the rendered frames 246 may include a rendered frame from each of the first subset of frames 154 (e.g., three rendered frames 246 from the three frames 154 of the input video 102).

Subsequently, at block 248, a loss function may be performed based on comparing the rendered frames 246 with the original frames from the input video 102. For example, initially, the rendered frames 246 for the first subset of video frames 154 (e.g., the first three frames) may be compared to the first subset of video frames 154 using a loss function. Based on the comparison, a global optimization loss may be determine and the 3D Gaussian parameters as well as camera poses across all processed frames may be optimized, which may ensure geometric consistency across the entire sequence including reducing accumulated pose drift and local misalignments. For instance, based on the comparison, the determined octree anchor formations (e.g., the initial octree anchor formations 208) may be updated such as the global scale parameter, the offsets, and/or the anchor features (e.g., the 3D Gaussian parameters such as the color parameters, scale parameters, rotation parameters, and/or opacity parameters). Further, the determined camera poses 242 may also be updated (e.g., the initial camera poses 212). In addition, the parameters of the MLP 244 may also be updated.

After performing the global optimization block 158 and returning back to FIG. 1C, the pose estimation block 162 is performed. For instance, the pose estimation block 162 may be perform PnP initialization (e.g., given correspondences between the predicted 3D anchor points from frame Tᵢ₋₁ and the 2D keypoints detected in frame Tᵢ, embodiments of the present disclosure may employ PnP with Random Sample Consensus (RANSAC) to robustly estimate an initial camera pose), pose refinement (e.g., the estimated pose is further refined by rasterizing the 3DGS scene and iteratively minimizing reprojection error to enhance pose accuracy), and anchor unprojection (e.g., newly observed regions are detected via an occlusion mask, computed by forward-warping the previous frame's rendered depth and these regions are unprojected into 3D and converted into anchors via octree anchor formation). FIGS. 2D-2F describe the pose estimation block 162.

FIG. 2D describes the PnP initialization process 250. For instance, the next frame of the video 160 may be provided to the 3D reconstruction model 254 (e.g., the MASt3R model). In addition, the previous frame of the video 252 (e.g., initially, the previous frame 252 may be the third frame of the video from the first subset of frames 154) may also be provided to the 3D reconstruction model 254. The 3D reconstruction model 254 may process the previous frame 252 and the next frame 160 to determine the 2D correspondence and the 3D point clouds for objects within the previous and next frames 252 and 160. For example, as mentioned previously in FIG. 2A, the 3D reconstruction model 254 may be used to generate the 3D point clouds within the frames such as the previous frame 252 and the next frame 160. In addition, using the 3D reconstruction model 254, the 2D correspondence 256 between the previous frame 252 and the next frame 160 may be determined. For instance, the 2D correspondence 256 may indicate correspondences between pixels between the previous frame 252 and the next frame 160. For example, in a captured input video 102 where the user capturing the video is moving, an object from one frame may shift slightly to the next frame. Thus, the 2D correspondence 256 may indicate the shift between the two subsequent frames 160 and 252, such as by indicating correspondences between the pixels between the two subsequent frames 160 and 252 (e.g., the pixels representing the object have shifted slightly to the left due to the movement of the user).

In addition, a 3D correspondence process 262 may be used to determine the 3D correspondence 264 for the previous frame 252. For instance, the 3D correspondence process 262 may include using the MLP (e.g., the MLP 244 that has been updated when performing the global optimization block 158) to render a depth frame for the previous frame, using a projection algorithm to generate a 3D projected scene for the third frame, and then using the 2D correspondence 256 determined from the 3D reconstruction model 254 to determine the 3D correspondence 264. Similar to the 2D correspondence, the 3D correspondence 264 may indicate correspondences (e.g., 3D correspondences) between pixels from the next frame 160 and the previous frame 252.

The 2D correspondence 256 and the 3D correspondence 264 are processed by the estimated camera pose algorithm 266 (e.g., a PnP algorithm with RANSAC) to determine an output. The output may indicate a failure due to insufficient feature correspondences and/or poor initialization. If so, the process 250 triggers a fallback mechanism by moving to block 268 where the global optimization block 158 is performed again to re-optimize all past frames globally before retrying pose estimation. This iterative fallback may enhance robustness under challenging motion or weak texture. Otherwise, the output may indicate a success and the estimated camera pose 270 for the next frame (e.g., the fourth frame) is determined.

Using the estimated camera pose 270 and the 3D point clouds 258, an aligned depth map 260 may be generated. The aligned depth map 260 and/or the estimated camera pose 270 for the next frame may be used in the further processes of the pose estimation block 162 and/or the overall training process 114. For instance, the pose refinement process 272 is shown in FIG. 2E.

As shown, the MLP 244 may process the camera poses and the 3D point clouds to generate RGB and depth images (e.g., the MLP 244 may decode the Gaussian attributes, and a Gaussian rasterizer such as an EWA renderer may perform the actual image rendering). For instance, initially, the 3D point clouds for the previous frames 274 and the camera poses for the previous frames 276 may be the 3D point clouds 204 and the camera poses 212 for the first subset of frames 154. The estimated camera pose 278 for the next frame and the 3D point clouds 258 for objects within the next frame may be obtained based on performing the process 250 described above. As such, two sets of depth images and RGB images are generated—a first set for the previous frames (e.g., the rendered depth images for the previous frames 280 and the rendered RGB images for the previous frames 282) and a second set for the next frame (e.g., the rendered depth image for the next frame 284 and the rendered RGB image for the next frame 286). Then, a loss function 288 is used to determine losses based on the two sets of depth and RGB images. Afterwards, at block 290, the estimated camera pose is updated based on the loss function. Subsequently, the process 272 may be performed one or more additional iterations except using the updated estimated camera pose based on performing block 290 instead of the estimated camera pose from the process 250. In other words, process 272 may be performed one or more iterations to continue to refine the estimated camera pose for the next frame 278.

The anchor unprojection algorithm 294 is described in FIG. 2F. For instance, using the aligned depth map 260 from FIG. 2D and the updated estimated camera pose 292 (e.g., after performing one or more additional iterations of FIG. 2E), an anchor unprojection algorithm 294 may be used to determine unprojected 3D point clouds 296 for the objects in the next frame. Then, using the unprojected 3D point clouds 296, the initial octree anchor formation process 206, which is described by FIG. 2B above, is performed to determine the octree anchor formations for the next frame 298. As such, the pose estimation block 162 may incrementally expand the scene while maintaining structural regularity.

In some examples, the anchor unprojection algorithm 294 may include three steps. First, the anchor unprojection algorithm 294 may rescale the 3D reconstruction model's depth (e.g., MASt3R's depth) to the scene's current metric scale. A scalar ŝₜ may be computed by least-squares aligning the previous frame's rendered depth Dₜ₋₁ with MASt3R's aligned depth

$${D}_{t}^{align}$$

(e.g., Equation (10) below), and the current frame's depth map may be scale as \hat{D}ₜ=ŝₜ.

$${D}_{t}^{align} .$$

This may correct the 3D reconstruction model's frame-wise scale drift. Second, the depth rendered from the previous frame may be forward-warped into the current view and mark newly visible regions and form the occlusion mask. Third, every masked pixel uᵢ may back-projected to 3D with:

pᵢ=\hat{D}(uᵢ)·K⁻¹uᵢ (7)

yielding a point cloud in the current camera frame that is sent to anchor formation to create new anchors for the next frame. As such, the above expression may be for back-projecting 3D points in the current camera frame. Further, K may indicate a camera intrinsic matrix and uᵢ may indicate a pixel in homogeneous coordinates. \hat{D}ₜ may indicate a scale-corrected depth for the current frame based on ŝₜ, which may be a scalar for correcting scale drift that is estimated by least-squares alignment, and

$${D}_{t}^{align} ,$$

which may be the MASt3R's aligned depth at frame t. Further, Dₜ₋₁ may be the rendered depth from the previous frame.

In other words, for each new frame t, the 3D reconstruction model (e.g., MASt3R) provides 2D correspondences

$$\{ ( {x}_{i} , {x}_{i}^{′} ) \}$$

between name t and t−1, allowing backprojection of matched points xᵢ to 3D via:

Xᵢ=Dₜ₋₁(xᵢ)·K⁻¹\tilde{x}ᵢ (8)

These 2D-3D correspondences

$$\{ ( {x}_{i}^{′} , {X}_{i} ) \}$$

are used to solve the initial pose Tₜ via PnP, followed by photometric refinement that minimizes:

$${ℒ}_{phtoo} = {\sum }_{p ∈ Ω} {‖ {I}_{t} ( p ) - {\hat{I}}_{t} ( p ) ‖}^{2} \qquad ( 9 )$$

where Iₜ is the observed frame and Îₜ is the rendering using the current 3DGS. This ensures the pose aligns with the evolving scene.

To correct MASt3R's depth scale drift, embodiments of the present disclosure compute a scale factor ŝₜ by comparing the rendered depth Dₜ₋₁ and MASt3R's aligned depth

$${D}_{t}^{align} :$$

$${\hat{s}}_{t} = \frac{〈 {D}_{t - 1} , {D}_{t}^{align} 〉}{〈 {D}_{t}^{align} , {D}_{t}^{align} 〉} \qquad ( 10 )$$

This rescaled depth ensures consistent scale across frames.

As the camera moves, newly visible regions are detected via an occlusion mask M_{occ}, derived by forward-warping Dₜ₋₁ to frame t and comparing it to the rescaled depth

$${D}_{t}^{MASt 3 R} .$$

Newly visible pixels are unprojected into 3D using Equation (7) above.

These new points are converted into hierarchical octree anchors using the octree anchor formation process 206, with overlapping anchors removed to avoid. This process incrementally expands the scene while maintaining structural regularity.

Returning to FIG. 1C, after performing the pose estimation block 162, the local optimization block 164 may be performed. For example, the local optimization block 164 may be described by FIG. 2G.

For instance, at block 302, a visibility window may be calculated. For example, once the camera pose is estimated (e.g., the updated estimated camera pose 292 is determined using the pose estimation block 162), the local optimization block 164 may optimize only the Gaussians visible in the new frame's frustum, while constraining them with observations from nearby frames in a dynamically selected visibility-adapted local window. For instance, co-visibility between frames may be measured by:

$$IoU ( t , {t}^{′} ) = \frac{\vert V ( t ) ⋂ V ( {t}^{′} ) \vert}{\vert V ( t ) ⋃ V ( {t}^{′} ) \vert} \qquad ( 11 )$$

where [symbol] (t) denotes the set of Gaussians visible in frame t. Frames with co-visibility (e.g., below a co-visibility threshold τ) are excluded from the window. This adaptive mechanism ensures local Gaussians are consistently supervised by reliable multi-view constraints, balancing efficiency and accuracy. In other words, using the above expression, co-visibilities between the next frame 160 (e.g., the fourth frame) and the previous frames (e.g., the first subset of frames 154) may be determined. Then, based on comparing the co-visibilities with a co-visibility threshold τ, frames may be excluded from analysis during the local optimization block 164 (e.g., the first and second frames may show substantially different objects than the fourth frame and thus may be excluded).

Afterwards, at block 304, the octree anchor formations may be filtered using the calculated visibility window 302 to obtain the filtered octree anchor formations. These filtered octree anchor formations, along with the estimated camera pose for the next frame 292, may be provided to the MLP 244. The MLP 244 may process the inputs to generate the rendered frames 306 within the visibility window. Then, similar to the global optimization block 158, a loss function 308 may compare the rendered frames within the visibility window 306 with the next frame 160 to determine a local optimization loss. Subsequently, the octree anchor formations 304, the estimated camera pose 292, and the parameters of the MLP 244 may be updated based on the comparison and/or the local optimization loss. In other words, the local optimization block 164 may perform a similar process to the global optimization block 158 except that the local optimization block 164 uses a calculated visibility window to constrain the Gaussians visible in the frustrum of the new frame (e.g., the next frame 160).

Subsequently, the training process 114 may loop around to the global optimization block 158 and then the pose estimation block 162 except that a new next frame 160 (e.g., a fifth frame of the input video 102) is processed. This may continue until all frames from the input video 102 are processed. Thus, to handle casually captured long videos (e.g., the input video 102), the LongSplat framework 104 adopts a progressive incremental optimization approach that alternates between per-frame local reconstruction and cross-frame global consistency refinement.

Afterwards, in a final step, a final global refinement that jointly optimizes all Gaussians and camera poses over the sequence is performed. This final pass may further improve both rendering quality and long-range pose consistency. For example, during this final pass, one or more loss functions may be utilized and/or determined such as, but not limited to, a photo loss [symbol] ₚₕₒₜₒ, a depth loss [symbol] _{depth}, and a reprojection loss [symbol] _{reprojection}. The total loss [symbol] ₜₒₜₐₗ through the entire incremental reconstruction pipeline may be determined such as based on the below expression:

[symbol]

ₜₒₜₐₗ= [symbol] ₚₕₒₜₒ+λ_{depth} [symbol] _{depth}+λ_{reprojection} [symbol] _{reprojection} (12)

where λ_{depth} and λ_{reprojection} indicate weights for the depth loss and reprojection loss respectively. Afterwards, one or more features from the training process 114 such as the parameters of the MLP 244, the octree anchor formations, and/or the estimated camera poses may be further refined and/or updated. Thus, this combined loss applies to both local and global optimization stages, ensuring coherent multi-view, robust pose refinement, and stable geometry reconstruction across the evolving scene.

In other words, the training process 114 may use monocular depth and/or keypoint losses. For instance, to provide additional supervision in newly revealed regions, where multi-view observations are insufficient, embodiments of the present disclosure may use two regularization terms. A monocular depth loss may encourage rendered depth to match MASt3R's scale-aligned depth prior:

[symbol]

_{depth}=∥D^{rendered}−D^{MASt3R}∥² (13)

Additionally, a keypoint reprojection loss enforces alignment between projected 3D keypoints and their 2D observations:

$${ℒ}_{reprojection} = {\sum }_{k} {‖ π ( {X}_{k} ) - {u}_{k} ‖}^{2} \qquad ( 14 )$$

where π(·) denotes projection using the current pose.

Throughout the entire incremental reconstruction pipeline, each processed frame may be optimized using the total loss, which is described in Equation (12) above. This combined loss may apply to both local and global optimization stages, ensuring coherent multi-view, robust pose refinement, and stable geometry reconstruction across the evolving scene.

Among other benefits and advantages, embodiments of the present disclosure provide an incremental joint optimization process that concurrently optimizes camera poses and 3D Gaussians to avoid local minima and ensure global consistency, a pose estimation process that leverages learned 3D priors and an adaptive octree anchor formation mechanism and process that dynamically adjusts anchor densities, which may significantly reduce memory usage.

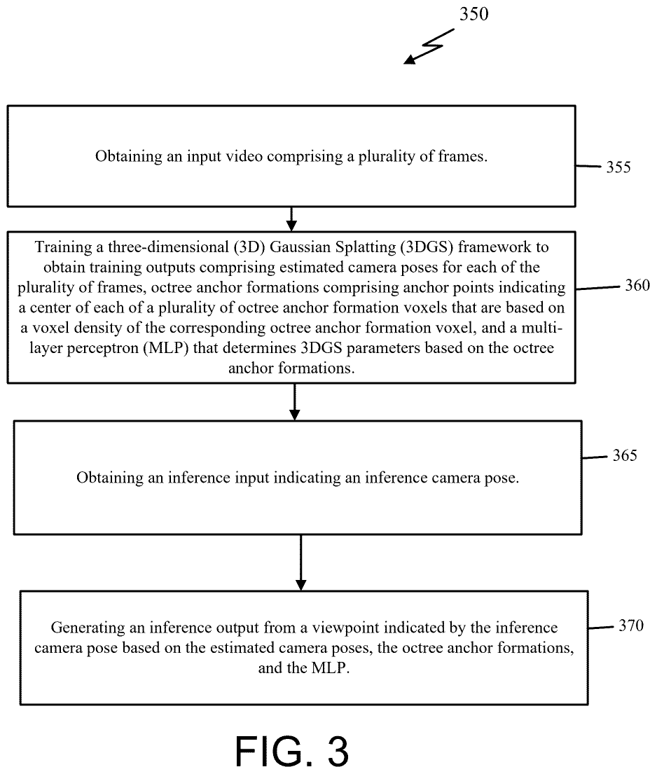

FIG. 3 illustrates a flowchart of a method 350 for NVS using a 3DGS framework, in accordance with one or more embodiments of the present disclosure. Each block of method 350, described herein, comprises a computing process that may be performed using any combination of hardware, firmware, and/or software. For instance, various functions may be carried out by a processor executing instructions stored in memory. The method 350 may also be embodied as computer-usable instructions stored on computer storage media. The method 350 may be provided by a standalone application, a service or hosted service (standalone or in combination with another hosted service), or a plug-in to another product, to name a few. In addition, method 350 is described, by way of example, with respect to the aspects described above in FIGS. 1A-1C and 2A-2G. However, the method 350 may additionally or alternatively be executed by any one system, or any combination of systems, including, but not limited to, those described herein. Furthermore, persons of ordinary skill in the art will understand that any system that performs method 350 is within the scope and spirit of embodiments of the present disclosure.

At step 355, an input video comprising a plurality of frames is obtained.

At step 360, a 3DGS framework is trained to obtain training outputs comprising estimated camera poses for each of the plurality of frames, octree anchor formations comprising anchor points indicating a center of each of a plurality of octree anchor formation voxels that are based on a voxel density of the corresponding octree anchor formation voxel, and a multi-layer perceptron (MLP) that determines 3DGS parameters based on the octree anchor formations.

In an embodiment, training the 3DGS framework comprises: separating the plurality of frames into a first subset of video frames and a second subset of video frames; initializing the 3DGS framework using the first subset of video frames to obtain initial camera poses for the first subset of video frames and initial octree anchor formations for objects within the first subset of video frames; and obtaining the training outputs based on the initial camera poses, the initial octree anchor formations, and the second subset of video frames. In an embodiment, initializing the 3DGS framework comprises: randomly initializing parameters of the MLP; processing the first subset of video frames using a 3D reconstruction model to generate 3D point clouds for the objects within the first subset of video frames; and determining the initial camera poses for the first subset of video frames and the initial octree anchor formations based on the 3D point clouds.

In an embodiment, determining the initial octree anchor formations comprises: separating a 3D scene associated with the input video into a plurality of voxels; determining first voxel densities for each voxel from the plurality of voxels; based on comparing the first voxel densities for each voxel from the plurality of voxels with a density threshold, separating at least one of the plurality of voxels into a plurality of additional voxels; determining second voxel densities for each voxel from the plurality of additional voxels; based on comparing the second voxel densities with the density threshold, determining the anchor points indicating center points for the plurality of voxels and the additional voxels; and generating the initial octree anchor formations based on the anchor points. In an embodiment, the generated initial octree anchor formations indicate a plurality of data structures associated with the plurality of octree anchor formation voxels, wherein each of the plurality of octree anchor formation voxels are voxels with voxel densities that do not exceed the density threshold, and wherein each of the plurality of data structures comprise an anchor point, from the anchor points, a plurality of offsets, anchor features, and a global scale parameter.

In an embodiment, obtaining the training outputs based on the initial camera poses, the initial octree anchor formations, and the second subset of video frames comprise: performing global optimization of the initial camera poses and the initial octree anchor formations; performing pose estimation for the second subset of video frames to determine estimated camera poses for each frame from the second subset of video frames; performing local optimization for the second subset of video frames; and obtaining the training outputs based on performing the global optimization, the pose estimation, and the local optimization. In an embodiment, performing the global optimization comprises: processing the initial camera poses and the initial octree anchor formations using the MLP to generate rendered frames for each of the first subset of frames; comparing the rendered frames with the first subset of frames using a loss function to determine a global optimization loss; and updating the initial octree anchor formations, the initial camera poses, and parameters of the MLP based on the global optimization loss. In an embodiment, performing the pose estimation comprises: estimating a camera pose for a next frame from the second subset of video frames using an estimated camera pose algorithm; performing pose refinement of the estimated camera pose for the next frame; and performing anchor unprojection to determine octree anchor formations for the next frame.

In an embodiment, estimating the camera pose for the next frame comprises: determining a two-dimensional (2D) correspondence between a frame from the first subset of video frames and the next frame based on using a 3D reconstruction model; determining a 3D correspondence between the frame from the first subset of video frames and the next frame based on the 2D correspondence and a projection algorithm that generates a 3D projected scene for the frame from the first subset of video frames; and processing the 2D correspondence and the 3D correspondence using the estimated camera pose algorithm to determine an output, wherein the estimated camera pose for the next frame is based on the output. In an embodiment, the output indicates a failure by the estimated camera pose algorithm to determine the estimated camera pose for the next frame, and wherein estimating the camera pose for the next frame further comprises: re-performing the global optimization of the initial camera poses and the initial octree anchor formations; and determining the estimated camera pose for the next frame based on re-performing the global optimization of the initial camera poses and the initial octree anchor formations. In an embodiment, performing the pose refinement comprises: using the MLP to generate a first set of rendered depth images and rendered red, green, blue (RGB) images for the first subset of frames; using the MLP to generate a second set of rendered depth images and rendered RGB images for the next frame; and based on comparing the first set with the second set, updating the estimated camera pose for the next frame.

In an embodiment, performing the local optimization comprises: calculating a visibility window based on a next frame from the second subset of video frames and the first subset of video frames; filtering the initial octree anchor formations based on the visibility window; processing an estimated camera pose for the next frame and the filtered initial octree anchor formations using the MLP to generate a rendered frame; comparing the rendered frame with the next frame using a loss function to determine a local optimization loss; and updating the estimated camera pose for the next frame and parameters of the MLP based on the local optimization loss. In an embodiment, obtaining the training outputs based on performing the global optimization, the pose estimation, and the local optimization comprises: determining a photo loss, a depth loss, and a reprojection loss based on performing the global optimization, the pose estimation, and the local optimization; determining a total loss based on the photo loss, the depth loss, and the reprojection loss; and obtaining the training outputs based on the total loss.

At step 365, an inference input indicating an inference camera pose is obtained.

At step 370, an inference output from a viewpoint indicated by the inference camera pose is generated based on the estimated camera poses, the octree anchor formations, and the MLP.

In an embodiment, at least one of steps 355-370 and/or the further steps described above are performed on a server or in a data center to generate the inference output, and the inference output is streamed to a user device. In an embodiment, at least one of steps 355-370 and/or the further steps described above is performed within a cloud computing environment. In an embodiment, at least one of steps 355-370 and/or the further steps described above is performed for training, testing, or certifying a neural network employed in a machine, robot, or autonomous vehicle. In an embodiment, at least one of steps 355-370 and/or the further steps described above is performed on a virtual machine comprising a portion of a graphics processing unit.

In an embodiment, the LongSplat framework 104 addresses critical challenges in NVS from casually captured long videos characterized by irregular camera motion, unknown camera poses, and/or expansive scenes. For example, prior approaches often suffer from pose drift, inaccurate geometry initialization, and/or severe memory limitations. To address these issues, the LongSplat framework 104 may integrate a correspondence-guided Pose Estimation module and/or process with 3DGS geometry and photometric refinements to improve pose accuracy, even under large-scale and unstructured camera motion. Furthermore, the LongSplat framework 104 may include an adaptive Octree Anchor Formation process and/or algorithm that dynamically adjusts anchor densities in the 3DGS representation, drastically reducing memory usage while preserving detailed scene structures. These components of the LongSplat framework 104 may work together in an incremental joint optimization approach that avoids local minima and ensures global geometric consistency across extensive sequences.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

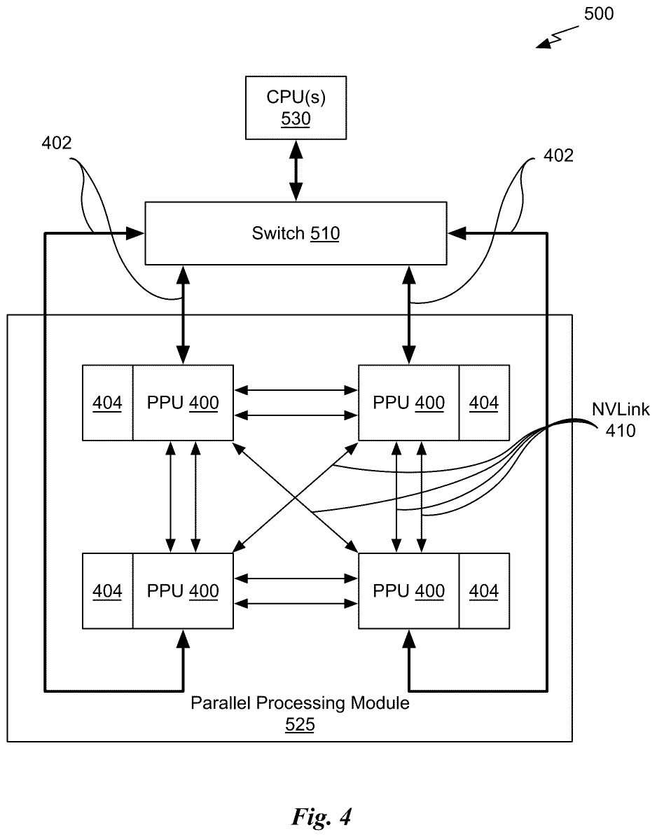

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

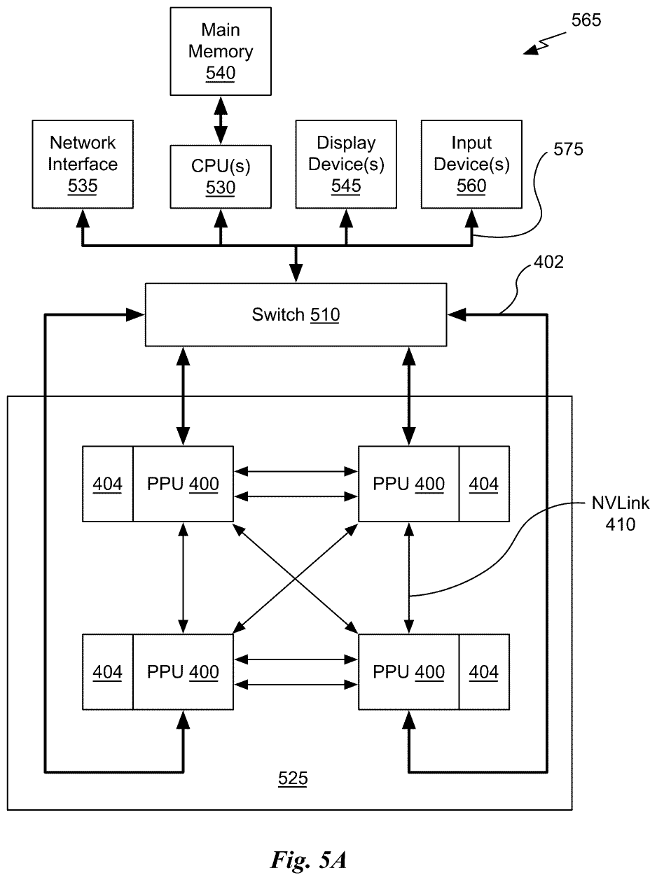

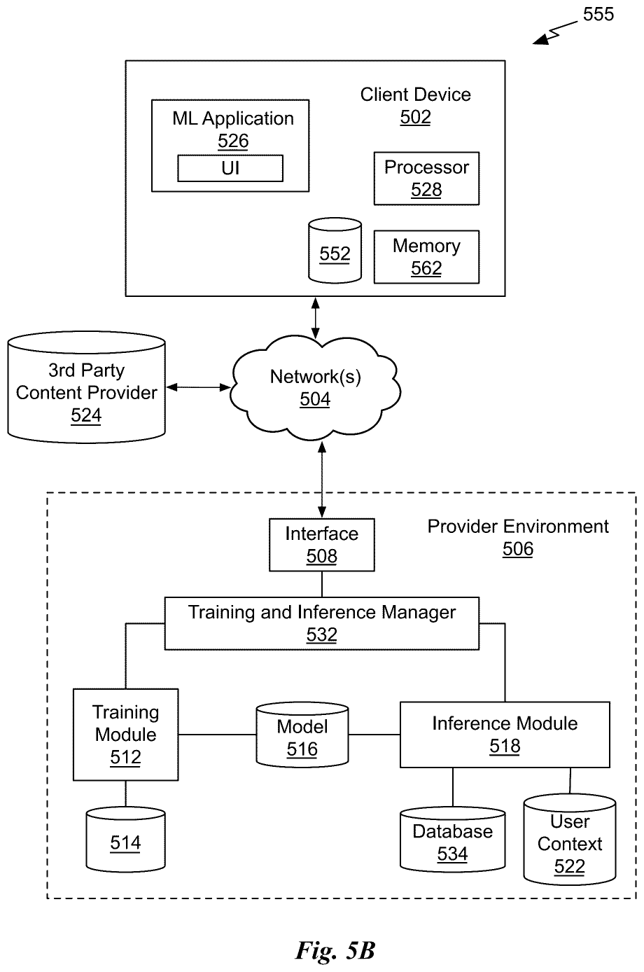

FIG. 5A illustrates an exemplary system 565 in which the various architecture and/or functionality of the various previous embodiments may be implemented. The exemplary system 565 may be configured to implement the method 350 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

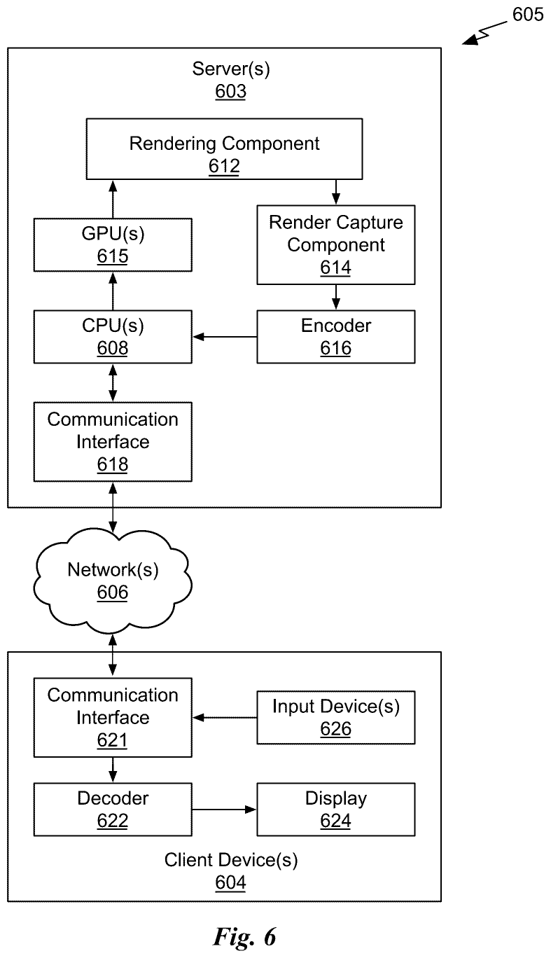

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for novel view synthesis (NVS) using a three-dimensional (3D) Gaussian Spatting (3DGS) framework, comprising:
obtaining an input video comprising a plurality of frames;
training the 3DGS framework to obtain training outputs comprising estimated camera poses for each of the plurality of frames and octree anchor formations comprising anchor points indicating a center of each of a plurality of octree anchor formation voxels that are based on a voxel density of the corresponding octree anchor formation voxel;
obtaining an inference input indicating an inference camera pose; and
generating an inference output from a viewpoint indicated by the inference camera pose based on the estimated camera poses and the octree anchor formations.

2. The computer-implemented method of claim 1, wherein the training outputs further comprise a multi-layer perceptron (MLP) that determines 3DGS parameters based on the octree anchor formations, and wherein generating the inference output from the viewpoint is further based on using the MLP.

3. The computer-implemented method of claim 2, wherein training the 3DGS framework comprises:
separating the plurality of frames into a first subset of video frames and a second subset of video frames;
initializing the 3DGS framework using the first subset of video frames to obtain initial camera poses for the first subset of video frames and initial octree anchor formations for objects within the first subset of video frames; and
obtaining the training outputs based on the initial camera poses, the initial octree anchor formations, and the second subset of video frames.

4. The computer-implemented method of claim 3, wherein initializing the 3DGS framework comprises:
randomly initializing parameters of the MLP;
processing the first subset of video frames using a 3D reconstruction model to generate 3D point clouds for the objects within the first subset of video frames; and
determining the initial camera poses for the first subset of video frames and the initial octree anchor formations based on the 3D point clouds.

5. The computer-implemented method of claim 4, wherein determining the initial octree anchor formations comprises:
separating a 3D scene associated with the input video into a plurality of voxels;
determining first voxel densities for each voxel from the plurality of voxels;
based on comparing the first voxel densities for each voxel from the plurality of voxels with a density threshold, separating at least one of the plurality of voxels into a plurality of additional voxels;
determining second voxel densities for each voxel from the plurality of additional voxels;
based on comparing the second voxel densities with the density threshold, determining the anchor points indicating center points for the plurality of voxels and the additional voxels; and
generating the initial octree anchor formations based on the anchor points.

6. The computer-implemented method of claim 5, wherein the generated initial octree anchor formations indicate a plurality of data structures associated with the plurality of octree anchor formation voxels, wherein each of the plurality of octree anchor formation voxels are voxels with voxel densities that do not exceed the density threshold, and wherein each of the plurality of data structures comprise an anchor point, from the anchor points, a plurality of offsets, anchor features, and a global scale parameter.

7. The computer-implemented method of claim 3, wherein obtaining the training outputs based on the initial camera poses, the initial octree anchor formations, and the second subset of video frames comprise:
performing global optimization of the initial camera poses and the initial octree anchor formations;
performing pose estimation for the second subset of video frames to determine estimated camera poses for each frame from the second subset of video frames;
performing local optimization for the second subset of video frames; and
obtaining the training outputs based on performing the global optimization, the pose estimation, and the local optimization.

8. The computer-implemented method of claim 7, wherein performing the global optimization comprises:
processing the initial camera poses and the initial octree anchor formations using the MLP to generate rendered frames for each of the first subset of frames;
comparing the rendered frames with the first subset of frames using a loss function to determine a global optimization loss; and
updating the initial octree anchor formations, the initial camera poses, and parameters of the MLP based on the global optimization loss.

9. The computer-implemented method of claim 7, wherein performing the pose estimation comprises:
estimating a camera pose for a next frame from the second subset of video frames using an estimated camera pose algorithm;
performing pose refinement of the estimated camera pose for the next frame; and
performing anchor unprojection to determine octree anchor formations for the next frame.

10. The computer-implemented method of claim 9, wherein estimating the camera pose for the next frame comprises:
determining a two-dimensional (2D) correspondence between a frame from the first subset of video frames and the next frame based on using a 3D reconstruction model;
determining a 3D correspondence between the frame from the first subset of video frames and the next frame based on the 2D correspondence and a projection algorithm that generates a 3D projected scene for the frame from the first subset of video frames; and
processing the 2D correspondence and the 3D correspondence using the estimated camera pose algorithm to determine an output, wherein the estimated camera pose for the next frame is based on the output.

11. The computer-implemented method of claim 10, wherein the output indicates a failure by the estimated camera pose algorithm to determine the estimated camera pose for the next frame, and wherein estimating the camera pose for the next frame further comprises:
re-performing the global optimization of the initial camera poses and the initial octree anchor formations; and
determining the estimated camera pose for the next frame based on re-performing the global optimization of the initial camera poses and the initial octree anchor formations.

12. The computer-implemented method of claim 9, wherein performing the pose refinement comprises:
using the MLP to generate a first set of rendered depth images and rendered red, green, blue (RGB) images for the first subset of frames;
using the MLP to generate a second set of rendered depth images and rendered RGB images for the next frame; and
based on comparing the first set with the second set, updating the estimated camera pose for the next frame.

13. The computer-implemented method of claim 7, wherein performing the local optimization comprises:
calculating a visibility window based on a next frame from the second subset of video frames and the first subset of video frames;
filtering the initial octree anchor formations based on the visibility window;
processing an estimated camera pose for the next frame and the filtered initial octree anchor formations using the MLP to generate a rendered frame;
comparing the rendered frame with the next frame using a loss function to determine a local optimization loss; and
updating the estimated camera pose for the next frame and parameters of the MLP based on the local optimization loss.

14. The computer-implemented method of claim 7, wherein obtaining the training outputs based on performing the global optimization, the pose estimation, and the local optimization comprises:
determining a photo loss, a depth loss, and a reprojection loss based on performing the global optimization, the pose estimation, and the local optimization;
determining a total loss based on the photo loss, the depth loss, and the reprojection loss; and
obtaining the training outputs based on the total loss.

15. The computer-implemented method of claim 1, wherein at least one of the steps of obtaining, training, and generating are performed on a server or in a data center to generate the inference output, and the inference output is streamed to a user device.

16. The computer-implemented method of claim 1, wherein at least one of the steps of obtaining, training, and generating are performed within a cloud computing environment.

17. The computer-implemented method of claim 1, wherein at least one of the steps of obtaining, training, and generating are performed for training, testing, or certifying a neural network employed in a machine, robot, or autonomous vehicle.

18. The computer-implemented method of claim 1, wherein at least one of the steps of obtaining, training, and generating are performed on a virtual machine comprising a portion of a graphics processing unit.

19. A system for novel view synthesis (NVS) using a three-dimensional (3D) Gaussian Spatting (3DGS) framework, comprising:
one or more processors; and
a non-transitory computer-readable medium having processor-executable instructions stored thereon, wherein the processor-executable instructions, when executed by the one or more processors, facilitate:
obtaining an input video comprising a plurality of frames;
training the 3DGS framework to obtain training outputs comprising estimated camera poses for each of the plurality of frames and octree anchor formations comprising anchor points indicating a center of each of a plurality of octree anchor formation voxels that are based on a voxel density of the corresponding octree anchor formation voxel;
obtaining an inference input indicating an inference camera pose; and
generating an inference output from a viewpoint indicated by the inference camera pose based on the estimated camera poses and the octree anchor formations.

20. The system of claim 19, wherein the training outputs further comprise a multi-layer perceptron (MLP) that determines 3DGS parameters based on the octree anchor formations, and wherein generating the inference output from the viewpoint is further based on using the MLP.

21. A non-transitory computer-readable medium having processor-executable instructions stored thereon for novel view synthesis (NVS) using a three-dimensional (3D) Gaussian Spatting (3DGS) framework, wherein the processor-executable instructions, when executed, facilitate:
obtaining an input video comprising a plurality of frames;
training the 3DGS framework to obtain training outputs comprising estimated camera poses for each of the plurality of frames and octree anchor formations comprising anchor points indicating a center of each of a plurality of octree anchor formation voxels that are based on a voxel density of the corresponding octree anchor formation voxel;
obtaining an inference input indicating an inference camera pose; and
generating an inference output from a viewpoint indicated by the inference camera pose based on the estimated camera poses and the octree anchor formations.

22. The non-transitory computer-readable medium of claim 20, wherein the training outputs further comprise a multi-layer perceptron (MLP) that determines 3DGS parameters based on the octree anchor formations, and wherein generating the inference output from the viewpoint is further based on using the MLP.
